(19) United States
(12) Patent Application Publication
(10) Pub. No.: US 2021/0210113 A1
(43) Pub. Date: Jul. 8, 2021

(54) METHOD AND APPARATUS FOR DETECTING VOICE

(71) Applicant: Beijing Baidu Netcom Science and Technology Co., Ltd., Beijing (CN)

(72) Inventors: Xin Li, Beijing (CN); Bin Huang, Beijing (CN); Ce Zhang, Beijing (CN); Jinfeng Bai, Beijing (CN); Lei Jia, Beijing (CN)

(21) Appl. No.: 17/208,387

(22) Filed: Mar. 22, 2021

(30) Foreign Application Priority Data
Jul. 20, 2020 (CN) 202010697058.1

(51) Int. Cl. G10L 25/30; G10L 15/02; G10L 25/78

(52) U.S. Cl. CPC G10L 25/30; G10L 25/78; G10L 15/02

(57) ABSTRACT

The present disclosure provides a method and apparatus for detecting a voice, relates to the fields of voice processing and deep learning technology. The method may include: acquiring a target voice; and inputting the target voice into a pre-trained deep neural network to obtain whether the target voice has a sub-voice in each of a plurality of preset direction intervals, the deep neural network being used to predict whether the voice has a sub-voice in each of the plurality of direction intervals.

### CROSS-REFERENCE TO RELATED APPLICATIONS

This application claims priority to Chinese Patent Application No. 202010697058.1, filed on Jul. 20, 2020, titled “Method and apparatus for detecting voice,” which is hereby incorporated by reference in its entirety.

### TECHNICAL FIELD

The present disclosure relates to the field of computer technology, in particular to the field of voice processing and deep learning technology, and more particular to a method and apparatus for detecting a voice.

### BACKGROUND

Direction of arrival (DOA) estimation is to estimate the direction of arrival of a wave, that is, to estimate the direction of a sound source. The source here may be an audio source or other signal source that may be used for communication. Voice activity detection (VAD) may detect whether a current audio includes a voice signal (i.e., human voice signal), that is, judge the audio and distinguish a human voice signal from various background noises.

### SUMMARY

A method and apparatus for detecting a voice, an electronic device and a storage medium are provided.

According to a first aspect, a method for detecting a voice is provided. The method includes: acquiring a target voice; and inputting the target voice into a pre-trained deep neural network to obtain whether the target voice has a sub-voice in each of a plurality of preset direction intervals, the deep neural network being used to predict whether the voice has a sub-voice in each of the plurality of direction intervals.

According to a second aspect, a method for training a deep neural network is provided. The method includes: acquiring a training sample, where a voice sample in the training sample includes a sub-voice in at least one preset direction interval; inputting the voice sample into the deep neural network to obtain a prediction result, the deep neural network being used to predict whether the voice has a sub-voice in each of a plurality of direction intervals; and training the deep neural network based on the prediction result, to obtain a trained deep neural network.

According to a third aspect, an apparatus for detecting a voice is provided. The apparatus includes: an acquisition unit, configured to acquire a target voice; and a prediction unit, configured to input the target voice into a pre-trained deep neural network to obtain whether the target voice has a sub-voice in each of a plurality of preset direction intervals, the deep neural network being used to predict whether the voice has a sub-voice in each of the plurality of direction intervals.

According to a fourth aspect, an apparatus for training a deep neural network is provided. The apparatus includes: a sample acquisition unit, configured to acquire a training sample, where a voice sample in the training sample comprises a sub-voice in at least one preset direction interval; an input unit, configured to input the voice sample into the deep neural network to obtain a prediction result, the deep neural network being used to predict whether the voice has a sub-voice in each of a plurality of direction intervals; and a training unit, configured to train the deep neural network based on the prediction result, to obtain a trained deep neural network.

According to a fifth aspect, an electronic device is provide. The electronic device includes: one or more processors; and a storage apparatus storing one or more programs. The one or more programs, when executed by the one or more processors, cause the one or more processors to implement the method for detecting a voice or the method for training a deep neural network according to any embodiment.

According to a sixth aspect, a computer readable storage medium is provide. The computer readable storage medium stores a computer program, the program, when executed by a processor, implements the method for detecting a voice or the method for training a deep neural network according to any embodiment.

### BRIEF DESCRIPTION OF THE DRAWINGS

By reading the detailed description of non-limiting embodiments with reference to the following accompanying drawings, other features, objectives and advantages of the present disclosure will become more apparent.

FIG. 1 is an example system architecture diagram in which some embodiments of the present disclosure may be implemented;

FIG. 2 is a flowchart of a method for detecting a voice according to an embodiment of the present disclosure;

FIG. 3A is a schematic diagram of an application scenario of the method for detecting a voice according to an embodiment of the present disclosure;

FIG. 3B is a schematic diagram of a prediction process of a deep neural network for voice detection according to an embodiment of the present disclosure;

FIG. 4A is a flowchart of a method for training a deep neural network according to an embodiment of the present disclosure;

FIG. 4B is a schematic diagram of a training network structure of a deep neural network for voice detection according to an embodiment of the present disclosure;

FIG. 5 is a schematic structural diagram of an apparatus for detecting a voice according to an embodiment of the present disclosure; and

FIG. 6 is a block diagram of an electronic device used to implement the method for detecting a voice according to embodiments of the present disclosure.

### DETAILED DESCRIPTION OF EMBODIMENTS

The following describes example embodiments of the present disclosure with reference to the accompanying drawings, which include various details of the embodiments of the present disclosure to facilitate understanding, and should be regarded as merely examples. Therefore, those of ordinary skill in the art should realize that various changes and modifications may be made to the embodiments described herein without departing from the scope and spirit of the present disclosure. Likewise, for clarity and conciseness, descriptions of well-known functions and structures are omitted in the following description.

It should be noted that the embodiments in the present disclosure and the features in the embodiments may be combined with each other on a non-conflict basis. The present disclosure will be described below in detail with reference to the accompanying drawings and in combination with the embodiments.

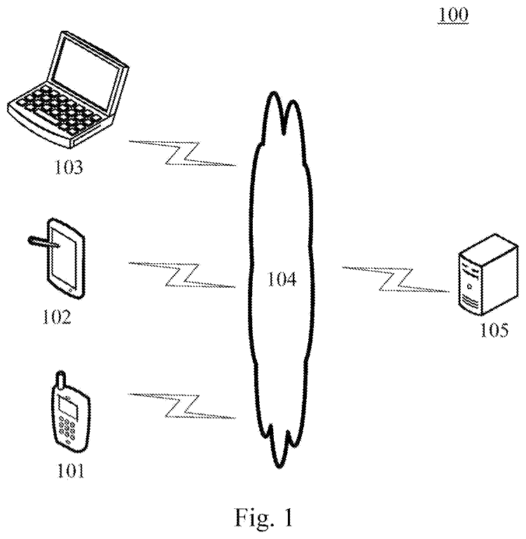

FIG. 1 illustrates an example system architecture 100 of a method for detecting a voice or an apparatus for detecting a voice in which embodiments of the present disclosure may be implemented.

As shown in FIG. 1, the system architecture 100 may include terminal devices 101, 102, and 103, a network 104, and a server 105. The network 104 is used to provide a communication link medium between the terminal devices 101, 102, and 103 and the server 105. The network 104 may include various types of connections, such as wired, wireless communication links, or optic fibers.

A user may interact with the server 105 through the network 104 using the terminal devices 101, 102 and 103 to receive or send messages and the like. Various communication client applications may be installed on the terminal devices 101, 102, 103, such as voice detection applications, live broadcast applications, instant messaging tools, email clients, or social platform software.

The terminal devices 101, 102, and 103 may be hardware or software. When the terminal devices 101, 102, and 103 are hardware, they may be various electronic devices having display screens, including but not limited to smart phones, tablet computers, E-book readers, laptop portable computers, desktop computers, or the like. When the terminal devices 101, 102, and 103 are software, they may be installed in the electronic devices listed above. They may be implemented as, for example, a plurality of software programs or software modules (for example, a plurality of software programs or software modules for providing distributed services), or as a single software program or software module, which is not specifically limited herein.

The server 105 may be a server that provides various services, for example, a backend server that provides support for the terminal devices 101, 102, and 103. The backend server may process such as analyze a received target voice and other data, and feed back a processing result (for example, a prediction result of a deep neural network) to the terminal devices.

It should be noted that the method for detecting a voice provided by the embodiments of the present disclosure may be performed by the server 105 or the terminal devices 101, 102 and 103, and accordingly, the apparatus for detecting a voice may be provided in the server 105 or the terminal devices 101, 102 and 103.

It should be understood that the number of terminal devices, networks, and servers in FIG. 1 is merely illustrative. Depending on the implementation needs, there may be any number of terminal devices, networks, and servers.

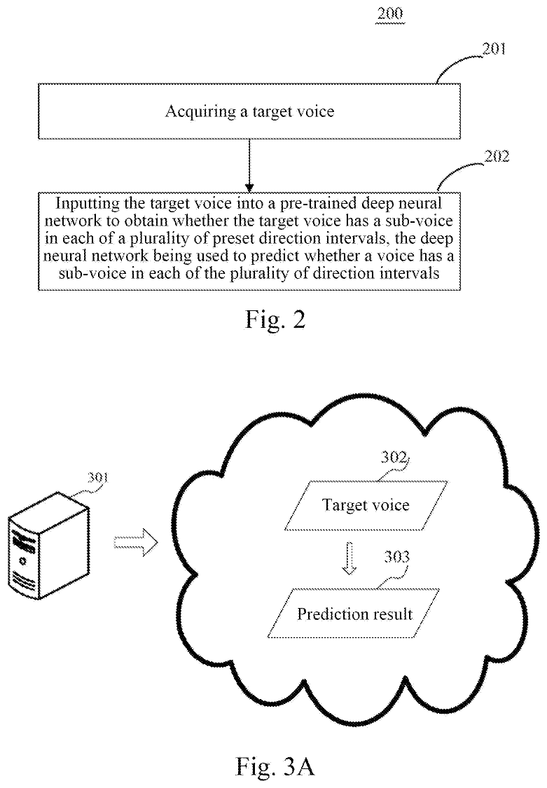

With further reference to FIG. 2, a flow 200 of a method for detecting a voice according to an embodiment of the present disclosure is illustrated. The method for detecting a voice includes the following steps.

Step 201, acquiring a target voice.

In the present embodiment, an executing body (for example, the server or terminal devices shown in FIG. 1) on which the method for detecting a voice operates may acquire the target voice. In practice, the target voice may be a single-channel voice or a multi-channel voice, that is, the target voice may be a voice received by one microphone, or a voice received by a microphone array composed of microphones in a plurality of different receiving directions.

Step 202, inputting the target voice into a pre-trained deep neural network to obtain whether the target voice has a sub-voice in each of a plurality of preset direction intervals, the deep neural network being used to predict whether a voice has a sub-voice in each of the plurality of direction intervals.

In the present embodiment, the executing body may input the target voice into the pre-trained deep neural network to obtain a prediction result output by the deep neural network. Specifically, the prediction result may be whether the target voice has the sub-voice in each of the plurality of preset direction intervals. The target voice is a voice emitted by at least one sound source, where each sound source emits one sub-voice in the target voice, and each sound source corresponds to one direction of arrival. It should be noted that in the present disclosure, a plurality of refers to at least two.

Specifically, the deep neural network here may be various networks, such as a convolutional neural network, a residual neural network, or the like.

The prediction result may include a result of predicting whether there is the sub-voice for each of the plurality of direction intervals. For example, all directions include 360°, and if each direction interval includes 120°, then the plurality of direction intervals may include 3 direction intervals. If each direction interval includes 36°, then the plurality of direction intervals may include 10 direction intervals. If each direction interval includes 30°, then the plurality of direction intervals may include 12 direction intervals.

The prediction result of the deep neural network may comprehensively and separately predict whether there is the sub-voice in each direction interval, and each direction interval has a corresponding result in the prediction result. For example, if there are 12 direction intervals, there may be 12 results in the prediction result, and different direction intervals correspond to different results in the 12 results.

In practice, the prediction result may be qualitative. For example, the prediction result may be “1” indicating that there is the sub-voice, or “0” indicating that there is no sub-voice. Alternatively, the prediction result may also be quantitative. For example, the prediction result may be a probability p indicating that the sub-voice exists, such as “0.96”, and a value range of the probability is [0, 1]. The prediction result may have a threshold value, such as 0.95, that is, if the probability is greater than or equal to the threshold value, then the target voice has the sub-voice in the direction interval. In addition, the prediction result may also indicate no sub-voice with a probability q, such as “0.06”, and a range of the probability is [1, 0]. The prediction result may also have a threshold value, such as 0.05, that is, if the probability is less than or equal to the threshold value, then the target voice has the sub-voice in the direction interval.

The method provided in the above embodiment of the present disclosure may separately predict each direction interval, so as to accurately determine whether the target voice has the sub-voice in each direction interval, thereby realizing accurate prediction.

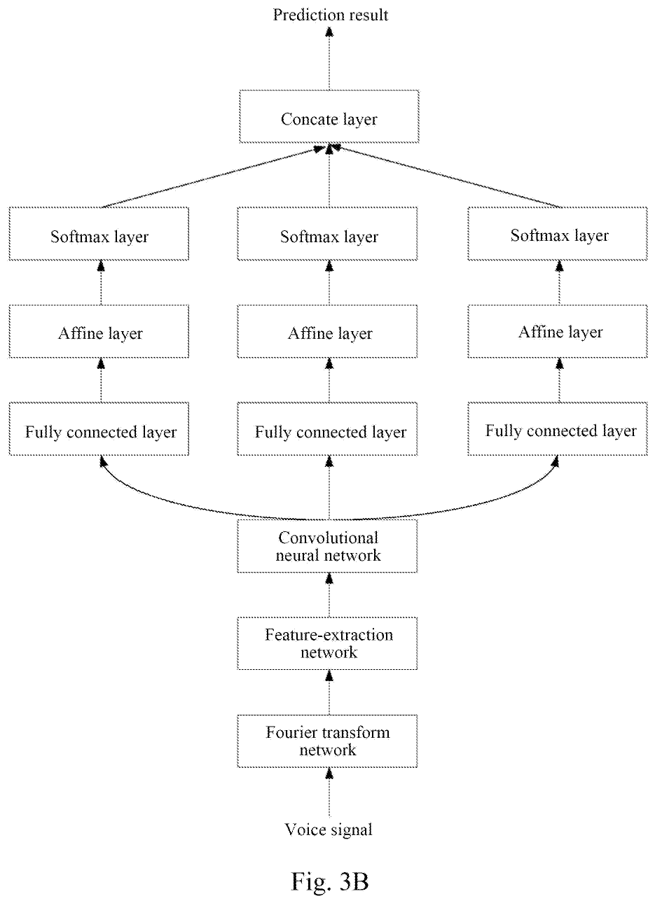

With further reference to FIG. 3A, FIG. 3A is a schematic diagram of an application scenario of the method for detecting a voice according to the present embodiment. In the application scenario of FIG. 3A, an executing body 301 acquires a target voice 302. The executing body 301 inputs the target voice 302 into a pre-trained deep neural network, to obtain a prediction result 303 of the deep neural network: whether the target voice has a sub-voice in each of 3 preset direction intervals. Specifically, there is a sub-voice in a first direction interval and a second direction interval, and no sub-voice in a third direction interval. The deep neural network is used to predict whether the input voice has a sub-voice in each of the above 3 direction intervals.

The present disclosure further provides another embodiment of the method for detecting a voice. The deep neural network includes a multi-head fully connected network, and an output of the multi-head fully connected network is used to represent whether the voice has a sub-voice in each of the plurality of direction intervals respectively, where direction intervals corresponding to any two fully connected networks in the multi-head fully connected network are different.

In the present embodiment, a fully connected network in the deep neural network may be a multi-head fully connected network. The executing body on which the method for detecting a voice operates (for example, the server or the terminal devices shown in FIG. 1) may use a plurality of fully connected networks included in the multi-head fully connected network to perform fully connected processing, and the prediction result output by the deep neural network may include all or part of the output of each fully connected network. There is a corresponding relationship between the fully connected network and the direction interval, that is, a fully connected network corresponds to a direction interval in a plurality of direction intervals. Accordingly, a fully connected network may predict whether the target voice has a sub-voice in the direction interval corresponding to the fully connected network.

An input of the multi-head fully connected network may be the same as an input of other fully connected networks in this field. For example, the input may be a voice feature of the target voice.

In the present embodiment, the multi-head fully connected network may be used to accurately predict sub-voices in different direction intervals.

In some alternative implementations of the present embodiment, a fully connected network in the multi-head fully connected network includes a fully connected layer, an affine layer and a softmax layer (logistic regression layer).

In these alternative implementations, the multi-head fully connected network may include the fully connected (FC) layer (for example, a fully connected layer FC-relu connected with an activity relu layer), the affine layer, and the softmax layer. These implementations may use processing layers in the fully connected network to perform more refined processing, which helps to obtain a more accurate prediction result.

In some alternative implementations of the present embodiment, the deep neural network further includes a feature-extraction network and a convolutional neural network. The inputting the target voice into a pre-trained deep neural network to obtain whether the target voice has a sub-voice in each of a plurality of preset direction intervals, may include: inputting the target voice into the pre-trained deep neural network, extracting a voice feature of the target voice based on the feature-extraction network; and processing the voice feature using the convolutional neural network to obtain a voice feature after convolution to be input into the multi-head fully connected network.

In these alternative implementations, the executing body may first use the feature-extraction (FE) network to extract the voice feature of the target voice, and use the convolutional neural network (CNN, such as a convolutional neural layer CNN-relu connected with an activity relu layer) to perform convolution on the voice feature, thereby obtaining the voice feature after convolution. Specifically, the convolutional neural network may include one or more than two convolutional layers. In addition, the convolutional neural network may also include an activation layer.

In practice, the executing body may use various methods to extract the voice feature of the target voice based on the feature-extraction network. For example, the feature-extraction network may be used to perform spectrum analysis. The executing body may use the feature-extraction network to perform spectrum analysis on the target voice, to obtain a spectrogram of the target voice, and use the spectrogram as the voice feature to be input into the convolutional neural network.

These implementations may extract the voice feature and perform convolution on the voice feature to extract the voice feature and perform more sufficient processing on the voice feature, which helps to allow the multi-head fully connected network make better use of the voice feature after convolution to obtain an accurate prediction result.

In some alternative application scenarios of these implementations, the deep neural network further includes a Fourier transform network; and the extracting a voice feature of the target voice based on the feature-extraction network in these implementations, may include: performing Fourier transform on the target voice using the Fourier transform network to obtain a plural form vector; normalizing a real part and an imaginary part of the vector using the feature-extraction network to obtain a normalized real part and a normalized imaginary part; and using the normalized real part and the normalized imaginary part as the voice feature of the target voice.

In these alternative application scenarios, the executing body may perform a fast Fourier transform (FFT) on the target voice, and a result obtained is a vector. Moreover, the vector is expressed in the plural form, for example, it may be expressed as x+yj, where x is the real part, y is the imaginary part, and j is the unit of the imaginary part. Correspondingly, x̅=x/\sqrt{x²+y²} is the normalized real part, and y̅=y/\sqrt{x²+y²} is the normalized imaginary part. It may be seen that the above normalized real part and normalized imaginary part include phase information in all directions. In the existing art, a phase of the vector obtained by FFT is often directly used as the voice feature, and due to the periodicity of the phase (generally 2π is used as the period), the phase calculated using this method often has several deviations of 2π from a true phase.

These application scenarios may determine the normalized real part and the normalized imaginary part as the voice feature, avoiding the problem of introducing a phase deviation in the existing art. In addition, a variety of features are determined for the voice, which helps to obtain a more accurate prediction result.

Alternatively, the method may further include: determining a logarithm of a modulus length of the vector using the feature-extraction network; and the using the normalized real part and the normalized imaginary part as the voice feature of the target voice, includes: using the normalized real part, the normalized imaginary part and the logarithm as the voice feature of the target voice.

Specifically, determining the modulus length for the vector in the plural form is to determine a root result of a sum of squares of the real part and the imaginary part of the vector.

The executing body may input the obtained normalized real part, normalized imaginary part and the logarithm to the convolutional neural network in three different channels to perform convolution. The logarithm may provide sufficient information for detecting a voice.

In some alternative application scenarios of these implementations, the inputting the target voice into a pre-trained deep neural network to obtain whether the target voice has a sub-voice in each of a plurality of preset direction intervals, may further include: for each fully connected network in the multi-head fully connected network, inputting the voice feature after convolution into the fully connected network to obtain a probability that the target voice has a sub-voice in a direction interval corresponding to the fully connected network.

In these alternative application scenarios, the executing body may input the voice feature after convolution output by the convolutional neural network into each fully connected network in the multi-head fully connected network, so as to obtain the probability that the target voice has the sub-voice in the direction interval corresponding to each fully connected network. In practice, the probability here may be the above probability p indicating that the sub-voice exists, and/or the probability q indicating no sub-voice.

These application scenarios may use the multi-head fully connected network to accurately determine the probability of whether the target voice has a sub-voice in each direction interval.

In some alternative cases of these application scenarios, the deep neural network may further include a concate layer (merging layer); and the inputting the target voice into a pre-trained deep neural network to obtain whether the target voice has a sub-voice in each of a plurality of preset direction intervals, may further include: merging probabilities corresponding to the multi-head fully connected network to obtain a to-be-output probability set.

In these alternative cases, the executing body may use the concate layer to merge probabilities obtained by the fully connected networks in the multi-head fully connected network, and use a merged processing result as the prediction result of the deep neural network.

If the prediction result of each fully connected network is a single probability, such as the probability p, the merging processing may be to merge the probabilities obtained by the fully connected networks into the probability set. If the prediction result of each fully connected network is at least two probabilities, such as the probability p and probability q, the merging processing may be to merge one of the at least two probabilities obtained by each fully connected network, such as the probability p, into the probability set. Specifically, if a loss function used in training of the deep neural network is a cross-entropy function, then the prediction result includes the probability p and probability q, and p+q=1. Therefore, one of the above probabilities, such as the probability p, may be selected as the prediction result for output.

In practice, the merging processing may also include transposition processing, which is represented by a symbol T, the probability set is a set of pₙ, and pₙ represents a probability that there is a sub-voice in a direction interval n, pₙ=[p₀, p₁, . . . , p_{N-1}]^{T}, where n=0, 1, . . . , N−1.

As shown in FIG. 3B, the figure shows the whole process of inputting voice information into the deep neural network for prediction to obtain a prediction result.

In these cases, the executing body may use the concate layer to merge the probabilities, so that the deep neural network may output at one time whether the target voice has a sub-voices in a plurality of direction intervals.

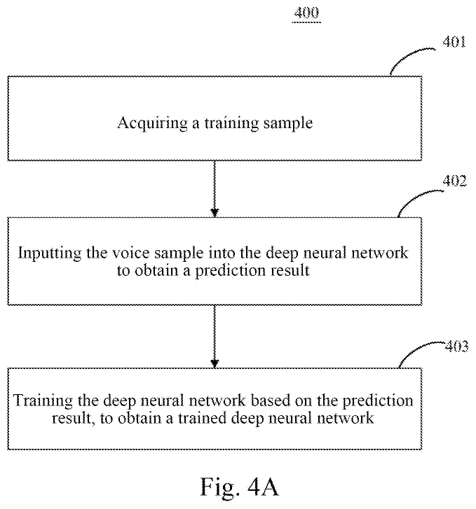

With further reference to FIG. 4A, a flow 400 of an embodiment of a method for training a deep neural network is illustrated. The flow 400 may include the following steps.

Step 401, acquiring a training sample, where a voice sample in the training sample includes a sub-voice in at least one preset direction interval.

In the present embodiment, an executing body (for example, the server or terminal devices shown in FIG. 1) on which the method for training a deep neural network operates may acquire the training sample. The training sample includes a voice sample for training, and the voice sample may include a sub-voice in one or more preset direction intervals.

Step 402, inputting the voice sample into the deep neural network to obtain a prediction result, the deep neural network being used to predict whether the voice has a sub-voice in each of a plurality of direction intervals.

In the present embodiment, the executing body may input the voice sample into the deep neural network, perform forward propagation in the deep neural network, to obtain the prediction result output by the deep neural network. Specifically, the deep neural network into which the voice sample is input is a to-be-trained deep neural network.

Step 403, training the deep neural network based on the prediction result, to obtain a trained deep neural network.

In the present embodiment, the executing body may train the deep neural network based on the prediction result, to obtain the trained deep neural network. The training sample may include a real result corresponding to the voice sample, that is, whether the voice sample has a sub-voice in each of the plurality of direction intervals.

Specifically, the executing body may determine a loss value based on the prediction result and the real result, and use the loss value to perform back propagation in the deep neural network, thereby obtaining the trained deep neural network.

In the present embodiment, the deep neural network obtained by training may separately predict for each direction interval, so as to accurately determine whether the voice has a sub-voice in each direction interval, realizing accurate prediction.

In some alternative implementations of the present embodiment, the deep neural network includes a multi-head fully connected network, and an output of the multi-head fully connected network is used to represent whether the voice has a sub-voice in each of the plurality of direction intervals respectively, where direction intervals corresponding to any two fully connected networks in the multi-head fully connected network are different.

In some alternative application scenarios of these implementations, step 402 may include: inputting the voice sample into the deep neural network, determining a feature of the voice sample using the deep neural network to obtain a to-be-processed voice feature, where the training sample further includes direction information of a sub-voice in the voice sample, and the to-be-processed voice feature includes a to-be-processed sub-voice feature corresponding to the sub-voice in the voice sample; determining, for each to-be-processed sub-voice feature of the sub-voice, in the multi-head fully connected network, a fully connected network corresponding to a direction interval in which a direction indicated by the direction information of the sub-voice is located, and using the fully connected network as a fully connected network into which the to-be-processed sub-voice feature is to-be-input; and determining whether the voice sample has a sub-voice in each of a plurality of direction intervals using the multi-head fully connected network.

In these alternative application scenarios, the executing body may determine the feature of the voice sample, and use the determined feature as the to-be-processed voice feature. Specifically, the executing body may use various methods to determine the feature of the voice sample. For example, the executing body may use a feature-extraction layer to extract the feature of the voice sample, and use the extracted feature as the to-be-processed voice feature. In addition, the executing body may also perform other processing on the extracted feature, and use a processing result as the to-be-processed voice feature. For example, the executing body may input the extracted feature into a preset model, and use a result output by the preset model as the to-be-processed voice feature.

The executing body may determine, for each to-be-processed sub-voice feature, the direction interval in which the direction indicated by the direction information of the sub-voice is located using a feature-oriented network, thereby determining the fully connected network corresponding to the direction interval, and use the corresponding fully connected network as the fully connected network into which the to-be-processed sub-voice feature is to-be-input.

The fully-connected network in the multi-head fully-connected network may output whether the voice sample has a sub-voice in each of the plurality of direction intervals.

In some alternative cases of these application scenarios, the determining, for each to-be-processed sub-voice feature of the sub-voice, in the multi-head fully connected network, a fully connected network corresponding to a direction interval in which a direction indicated by the direction information of the sub-voice is located, and using the fully connected network as a fully connected network into which the to-be-processed sub-voice feature is to-be-input, may include: determining, for each to-be-processed sub-voice feature of the sub-voice, in the multi-head fully connected network, the fully connected network corresponding to the direction interval in which the direction indicated by the direction information of the sub-voice is located using the feature-oriented network, and using the fully connected network as the fully connected network into which the to-be-processed sub-voice feature is to-be-input.

In these cases, the executing body may determine the fully connected network corresponding to each to-be-processed sub-voice feature using the feature-oriented network, that is, the fully connected network into which the to-be-processed sub-voice feature is to-be-input. Therefore, for each to-be-processed sub-voice feature, the executing body may input the to-be-processed sub-voice feature into the fully connected network corresponding to the to-be-processed sub-voice feature.

In these cases, the executing body may use the feature-oriented network to allocate the to-be-processed sub-voice features to the respective fully connected networks in the training process, so that each fully connected network learns the feature of the sub-voice in a specific direction interval during training, so as to improve an accuracy of detecting the sub-voice in the direction interval.

In some alternative cases of these application scenarios, the determining whether the voice sample has a sub-voice in each of a plurality of direction intervals using the multi-head fully connected network in these application scenarios, may include: for each to-be-processed sub-voice feature, using the to-be-processed sub-voice feature for forward propagation on the corresponding fully connected network to obtain a probability that the voice sample has a sub-voice in each of the plurality of direction intervals.

In these cases, the executing body may use each to-be-processed sub-voice feature to perform forward propagation on the fully connected network corresponding to each to-be-processed sub-voice feature. A result of the forward propagation is the probability that the voice sample has a sub-voice in each of the plurality of direction intervals.

In these cases, the executing body may make accurate prediction based on the probability of the sub-voice in each direction interval.

Alternatively, the determining a feature of the voice sample using the deep neural network to obtain a to-be-processed voice feature, may include: extracting the voice feature of the voice sample based on the feature-extraction network; and processing the extracted voice feature using the convolutional neural network to obtain the to-be-processed voice feature to be input into the multi-head fully connected network.

In this case, the executing body may use the feature-extraction network and the convolutional neural network to fully extract the feature of the voice sample, so as to facilitate subsequent use of the feature.

Alternatively, the deep neural network further includes a Fourier transform network; the extracting a voice feature of the voice sample based on the feature-extraction network, may include: performing Fourier transform on the voice sample using the Fourier transform network to obtain a plural form vector; normalizing a real part and an imaginary part of the vector using the feature-extraction network to obtain a normalized real part and a normalized imaginary part; and using the normalized real part and the normalized imaginary part as the voice feature of the voice sample.

In these cases, the executing body may determine the normalized real part and the normalized imaginary part as the voice feature, avoiding the problem of introducing a phase deviation in the existing art. In addition, a variety of features are determined for the voice, which helps the trained deep neural network predict a more accurate prediction result.

Alternatively, the training the deep neural network based on the prediction result, to obtain a trained deep neural network, may include: performing back propagation in the training network structure based on the obtained probability, to update a parameter of the convolutional neural network and a parameter of the multi-head fully connected network.

In practice, the executing body may determine a loss value of the obtained probability based on the obtained probability, the real result in the training sample such as a real probability (such as “1” for existence and “0” for non-existence), and a preset loss function (such as a cross-entropy function), and use the loss value to perform back propagation to update the parameter of the convolutional neural network and the parameter of the multi-head fully connected network.

Alternatively, the performing back propagation in the training network structure based on the obtained probability, to update a parameter of the convolutional neural network and a parameter of the multi-head fully connected network, may include: for each obtained probability, determining a loss value corresponding to the probability, and performing back propagation in the fully connected network that obtains the probability using the loss value, to obtain a first result corresponding to the probability; merging the obtained first results using the feature-oriented network to obtain a first result set; and performing back propagation in the convolutional neural network using the first result set to update the parameter of the convolutional neural network and the parameter of the multi-head fully connected network.

In practice, the executing body may use the probability obtained in each fully connected network, and the real result of whether the voice sample has a sub-voice in the direction interval corresponding to the fully connected network labeled in the training sample, that is, the real probability, and the preset loss function, to determine the loss value corresponding to the fully connected network. In addition, the loss value corresponding to the fully connected network is used to perform back propagation in the fully connected network, so as to obtain a result of the back propagation corresponding to each fully connected network, that is, the first result corresponding to each fully connected network.

The executing body may merge the first results corresponding to the respective fully connected networks using the feature-oriented network to obtain the first result set. Then, the executing body may perform back propagation in the convolutional neural network using the first result set to update the parameter of the convolutional neural network and the parameter of the multi-head fully connected network.

As shown in FIG. 4B, a training network structure of the deep neural network is shown in the figure, where the DOA-Splitter is the feature-oriented network.

In these implementations, back propagation may be performed in the convolutional neural network and the multi-head fully connected network to update the parameters in the two networks. Moreover, these implementations may also use the feature-oriented network to merge the back propagation results of the fully connected networks, so that back propagation may be continued in the convolutional neural network, realizing back propagation in the entire model and parameter updating.

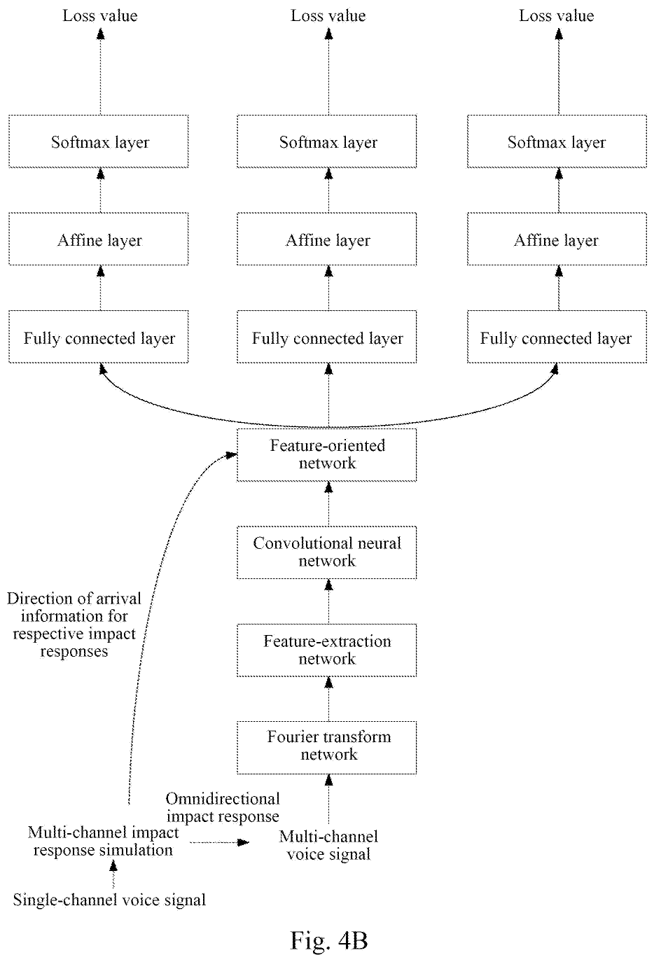

With further reference to FIG. 5, as an implementation of the method shown in FIG. 2 and FIG. 3 above, an embodiment of the present disclosure provides an apparatus for detecting a voice, and the apparatus embodiment corresponds to the method embodiment as shown in FIG. 2. In addition to the features described below, the apparatus embodiment may also include the same or corresponding features or effects as the method embodiment shown in FIG. 2. The apparatus may be specifically applied to various electronic devices.

As shown in FIG. 5, an apparatus 500 for detecting a voice of the present embodiment includes: an acquisition unit 501 and a prediction unit 502. The acquisition unit 501 is configured to acquire a target voice. The prediction unit 502 is configured to input the target voice into a pre-trained deep neural network to obtain whether the target voice has a sub-voice in each of a plurality of preset direction intervals, the deep neural network being used to predict whether the voice has a sub-voice in each of the plurality of direction intervals.

In the present embodiment, for the specific processing and technical effects thereof of the acquisition unit 501 and the prediction unit 502 in the apparatus 500 for detecting a voice, reference may be made to the relevant descriptions of step 201 and step 202 in the corresponding embodiment of FIG. 2 respectively, and repeated description thereof will be omitted.

In some alternative implementations of the present embodiment, the deep neural network includes a multi-head fully connected network, and an output of the multi-head fully connected network is used to represent whether the voice has the sub-voice in each of the plurality of direction intervals respectively, where direction intervals corresponding to any two fully connected networks in the multi-head fully connected network are different.

In some alternative implementations of the present embodiment, the deep neural network further includes a feature-extraction network and a convolutional neural network. The prediction unit is further configured to input the target voice into the pre-trained deep neural network to obtain whether the target voice has the sub-voice in each of the plurality of preset direction intervals by: inputting the target voice into the pre-trained deep neural network, and extracting a voice feature of the target voice based on the feature-extraction network; and processing the voice feature using the convolutional neural network to obtain a voice feature after convolution to be input into the multi-head fully connected network.

In some alternative implementations of the present embodiment, the deep neural network further includes a Fourier transform network. The prediction unit is further configured to perform the extracting the voice feature of the target voice based on the feature-extraction network by: performing Fourier transform on the target voice using the Fourier transform network to obtain a plural form vector; normalizing a real part and an imaginary part of the vector using the feature-extraction network to obtain a normalized real part and a normalized imaginary part; and using the normalized real part and the normalized imaginary part as the voice feature of the target voice.

In some alternative implementations of the present embodiment, the apparatus further includes: a determination unit, configured to determine a logarithm of a modulus length of the vector using the feature-extraction network. The prediction unit is further configured to use the normalized real part and the normalized imaginary part as the voice feature of the target voice by: using the normalized real part, the normalized imaginary part and the logarithm as the voice feature of the target voice.

In some alternative implementations of the present embodiment, the prediction unit is further configured to input the target voice into the pre-trained deep neural network to obtain whether the target voice has the sub-voice in each of the plurality of preset direction intervals by: for each fully connected network in the multi-head fully connected network, inputting the voice feature after convolution into the fully connected network to obtain a probability that the target voice has a sub-voice in a direction interval corresponding to the fully connected network.

In some alternative implementations of the present embodiment, the deep neural network further includes a concate layer. The prediction unit is further configured to input the target voice into the pre-trained deep neural network to obtain whether the target voice has the sub-voice in each of the plurality of preset direction intervals by: merging probabilities corresponding to the multi-head fully connected network to obtain a to-be-output probability set.

In some alternative implementations of the present embodiment, a fully connected network in the multi-head fully connected network includes a fully connected layer, an affine layer and a softmax layer.

In some alternative implementations of the present embodiment, a training network structure of the deep neural network further includes a feature-oriented network, a Fourier transform network, a feature-extraction network and a convolutional neural network. Training steps of the network structure include: perform forward propagation on a voice sample in a training sample in the Fourier transform network, the feature-extraction network and the convolutional neural network of the deep neural network to obtain a voice feature after convolution of the voice sample, the training sample including direction information of different sub-voices in the voice sample, and the voice feature after convolution including sub-voice features after convolution corresponding to the different sub-voices; determining, for each sub-voice feature after convolution of a sub-voice in the voice feature after convolution of the voice sample using the feature-oriented network, a fully connected network corresponding to a direction interval in which a direction indicated by the direction information of the sub-voice is located, and using the fully connected network as a fully connected network into which the sub-voice feature after convolution is to-be-input; performing forward propagation on the multi-head fully connected network to obtain a probability that the voice sample has a sub-voice in each of a plurality of direction intervals; and performing back propagation in the training network structure based on the obtained probability, to update a parameter of the convolutional neural networks and a parameter of the multi-head fully connected network.

In some alternative implementations of the present embodiment, the performing back propagation in the training network structure based on the obtained probability, to update a parameter of the convolutional neural networks and a parameter of the multi-head fully connected network, includes: for each obtained probability, determining a loss value corresponding to the probability, and performing back propagation in the fully connected network that obtains the probability using the loss value, to obtain a first result corresponding to the probability; merging the respective obtained first results using the feature-oriented network to obtain a first result set; and performing back propagation in the convolutional neural network using the first result set to update the parameter of the convolutional neural networks and the parameter of the multi-head fully connected network.

As an implementation of the method shown in the above figures, an embodiment of the present disclosure provides an apparatus for training a deep neural network. The apparatus embodiment corresponds to the method embodiment shown in FIG. 4A and FIG. 4B. In addition to the features described below, the apparatus embodiment may also include the same or corresponding features or effects as the method embodiment shown in FIG. 4A. The apparatus may be specifically applied to various electronic devices.

The apparatus for training a deep neural network of the present embodiment includes: a sample acquisition unit, an input unit and a training unit. The sample acquisition unit is configured to acquire a training sample, a voice sample in the training sample including a sub-voice in at least one preset direction interval. The input unit is configured to input the voice sample into the deep neural network to obtain a prediction result, the deep neural network being used to predict whether the voice has a sub-voice in each of a plurality of direction intervals. The training unit is configured to train the deep neural network based on the prediction result, to obtain a trained deep neural network.

In the present embodiment, for the specific processing and technical effects thereof of the sample acquisition unit, the input unit and the training unit in the apparatus for training a deep neural network, reference may be made to the relevant descriptions of step 401, step 402 and step 403 in the corresponding embodiment of FIG. 4A respectively, and repeated description thereof will be omitted.

In some alternative implementations of the present embodiment, the deep neural network includes a multi-head fully connected network, and an output of the multi-head fully connected network is used to represent whether the voice has a sub-voice in each of the plurality of direction intervals respectively, where direction intervals corresponding to any two fully connected networks in the multi-head fully connected network are different.

In some alternative implementations of the present embodiment, the input unit is further configured to input the voice sample into the deep neural network to obtain the prediction result by: inputting the voice sample into the deep neural network, determining a feature of the voice sample using the deep neural network to obtain a to-be-processed voice feature, where the training sample further includes direction information of each sub-voice in the voice sample, and the to-be-processed voice feature includes a to-be-processed sub-voice feature corresponding to each sub-voice in the voice sample; for each to-be-processed sub-voice feature of the sub-voice, determining, in the multi-head fully connected network, a fully connected network corresponding to a direction interval in which a direction indicated by the direction information of the sub-voice is located, and using the fully connected network as a fully connected network into which the to-be-processed sub-voice feature is to-be-input; and determining whether the voice sample has the sub-voice in each of the plurality of direction of arrival intervals using the multi-head fully connected network.

In some alternative implementations of the present embodiment, a training network structure of the deep neural network further includes a feature-oriented network. The input unit is further configured determine, for each to-be-processed sub-voice feature of the sub-voice, in the multi-head fully connected network, a fully connected network corresponding to a direction in which the direction indicated by the direction information of the sub-voice is located, and use the fully connected network as the fully connected network into which the to-be-processed sub-voice feature is to-be-input by: for each to-be-processed sub-voice feature of the sub-voice, determining, using the feature-oriented network, in the multi-head fully connected network the fully connected network corresponding to the direction interval in which the direction indicated by the direction information of the sub-voice is located, and using the fully connected network as the fully connected network into which the to-be-processed sub-voice feature is to-be-input.

In some alternative implementations of the present embodiment, the input unit is further configured to determine whether the voice sample has the sub-voice in each of the plurality of direction intervals using the multi-head fully connected network by: for each to-be-processed sub-voice feature, using the to-be-processed sub-voice feature for forward propagation on the corresponding fully connected network to obtain a probability that the voice sample has the sub-voice in each of the plurality of direction intervals.

In some alternative implementations of the present embodiment, the deep neural network further includes a feature-extraction network and a convolutional neural network. The input unit is further configured to determine a feature of the voice sample using the deep neural network to obtain a to-be-processed voice feature by: extracting a voice feature of the voice sample based on the feature-extraction network; and processing the extracted voice feature using the convolutional neural network to obtain the to-be-processed voice feature to be input into the multi-head fully connected network.

In some alternative implementations of the present embodiment, the deep neural network further includes a Fourier transform network; the input unit is further configured to extract the voice feature of the voice sample based on the feature-extraction network by: performing Fourier transform on the voice sample using the Fourier transform network to obtain a plural form vector; normalizing a real part and an imaginary part of the vector using the feature-extraction network to obtain a normalized real part and a normalized imaginary part; and using the normalized real part and the normalized imaginary part as the voice feature of the voice sample.

In some alternative implementations of the present embodiment, the training unit is further configured to train the deep neural network based on the prediction result, to obtain the trained deep neural network by: performing back propagation in the training network structure based on the obtained probability, to update a parameter of the convolutional neural network and a parameter of the multi-head fully connected network.

In some alternative implementations of the present embodiment, the training unit is further configured to perform the performing back propagation in the training network structure based on the obtained probability, to update the parameter of the convolutional neural network and the parameter of the multi-head fully connected network by: for each obtained probability, determining a loss value corresponding to the probability, and performing back propagation in the fully connected network that obtains the probability using the loss value, to obtain a first result corresponding to the probability; merging the obtained first results using the feature-oriented network to obtain a first result set; and performing back propagation in the convolutional neural networks using the first result set to update the parameter of the convolutional neural networks and the parameter of the multi-head fully connected network.

According to an embodiment of the present disclosure, the present disclosure further provides an electronic device and a readable storage medium.

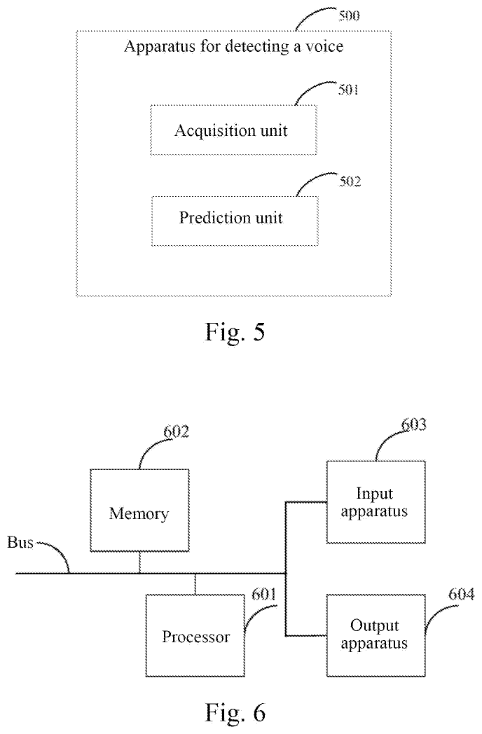

As shown in FIG. 6, is a block diagram of an electronic device of the method for detecting a voice according to an embodiment of the present disclosure, and is also a block diagram of an electronic device of the method for training a deep neural network. The block diagram of the electronic device of the method for detecting a voice is used as an example for the description as follows.

The electronic device is intended to represent various forms of digital computers, such as laptop computers, desktop computers, workbenches, personal digital assistants, servers, blade servers, mainframe computers, and other suitable computers. The electronic device may also represent various forms of mobile apparatuses, such as personal digital processing, cellular phones, smart phones, wearable devices, and other similar computing apparatuses. The components shown herein, their connections and relationships, and their functions are merely examples, and are not intended to limit the implementation of the present disclosure described and/or claimed herein.

As shown in FIG. 6, the electronic device includes: one or more processors 601, a memory 602, and interfaces for connecting various components, including high-speed interfaces and low-speed interfaces. The various components are connected to each other using different buses, and may be installed on a common motherboard or in other methods as needed. The processor may process instructions executed within the electronic device, including instructions stored in or on the memory to display graphic information of GUI on an external input/output apparatus (such as a display device coupled to the interface). In other embodiments, a plurality of processors and/or a plurality of buses may be used together with a plurality of memories if desired. Similarly, a plurality of electronic devices may be connected, and the devices provide some necessary operations (for example, as a server array, a set of blade servers, or a multi-processor system). In FIG. 6, one processor 601 is used as an example.

The memory 602 is a non-transitory computer readable storage medium provided by the present disclosure. The memory stores instructions executable by at least one processor, so that the at least one processor performs the method for detecting a voice provided by the present disclosure. The non-transitory computer readable storage medium of the present disclosure stores computer instructions for causing a computer to perform the method for detecting a voice provided by the present disclosure.

The memory 602, as a non-transitory computer readable storage medium, may be used to store non-transitory software programs, non-transitory computer executable programs and modules, such as program instructions/modules corresponding to the method for detecting a voice in the embodiments of the present disclosure (for example, the acquisition unit 501 and the prediction unit 502 as shown in FIG. 5). The processor 601 executes the non-transitory software programs, instructions, and modules stored in the memory 602 to execute various functional applications and data processing of the server, that is, to implement the method for detecting a voice in the method embodiments.

The memory 602 may include a storage program area and a storage data area, where the storage program area may store an operating system and at least one function required application program; and the storage data area may store data created by use of the electronic device for detecting a voice. In addition, the memory 602 may include a high-speed random access memory, and may also include a non-transitory memory, such as at least one magnetic disk storage device, a flash memory device, or other non-transitory solid-state storage devices. In some embodiments, the memory 602 may optionally include memories remotely provided with respect to the processor 601, and these remote memories may be connected to the electronic device for detecting a voice through a network. Examples of the above network include but are not limited to the Internet, intranet, local area network, mobile communication network, and combinations thereof.

The electronic device of the method for detecting a voice may further include: an input apparatus 603 and an output apparatus 604. The processor 601, the memory 602, the input apparatus 603, and the output apparatus 604 may be connected through a bus or in other methods. In FIG. 6, connection through a bus is used as an example.

The input apparatus 603 may receive input digital or character information, and generate key signal inputs related to user settings and function control of the electronic device of the method for detecting a voice, such as touch screen, keypad, mouse, trackpad, touchpad, pointing stick, one or more mouse buttons, trackball, joystick and other input apparatuses. The output apparatus 604 may include a display device, an auxiliary lighting apparatus (for example, LED), a tactile feedback apparatus (for example, a vibration motor), and the like. The display device may include, but is not limited to, a liquid crystal display (LCD), a light emitting diode (LED) display, and a plasma display. In some embodiments, the display device may be a touch screen.

Various embodiments of the systems and technologies described herein may be implemented in digital electronic circuit systems, integrated circuit systems, dedicated ASICs (application specific integrated circuits), computer hardware, firmware, software, and/or combinations thereof. These various embodiments may include: being implemented in one or more computer programs that can be executed and/or interpreted on a programmable system that includes at least one programmable processor. The programmable processor may be a dedicated or general-purpose programmable processor, and may receive data and instructions from a storage system, at least one input apparatus, and at least one output apparatus, and transmit the data and instructions to the storage system, the at least one input apparatus, and the at least one output apparatus.

These computing programs (also referred to as programs, software, software applications, or codes) include machine instructions of the programmable processor and may use high-level processes and/or object-oriented programming languages, and/or assembly/machine languages to implement these computing programs. As used herein, the terms “machine readable medium” and “computer readable medium” refer to any computer program product, device, and/or apparatus (for example, magnetic disk, optical disk, memory, programmable logic apparatus (PLD)) used to provide machine instructions and/or data to the programmable processor, including machine readable medium that receives machine instructions as machine readable signals. The term “machine readable signal” refers to any signal used to provide machine instructions and/or data to the programmable processor.

In order to provide interaction with a user, the systems and technologies described herein may be implemented on a computer, the computer has: a display apparatus for displaying information to the user (for example, CRT (cathode ray tube) or LCD (liquid crystal display) monitor); and a keyboard and a pointing apparatus (for example, mouse or trackball), and the user may use the keyboard and the pointing apparatus to provide input to the computer. Other types of apparatuses may also be used to provide interaction with the user; for example, feedback provided to the user may be any form of sensory feedback (for example, visual feedback, auditory feedback, or tactile feedback); and any form (including acoustic input, voice input, or tactile input) may be used to receive input from the user.

The systems and technologies described herein may be implemented in a computing system that includes backend components (e.g., as a data server), or a computing system that includes middleware components (e.g., application server), or a computing system that includes frontend components (for example, a user computer having a graphical user interface or a web browser, through which the user may interact with the implementations of the systems and the technologies described herein), or a computing system that includes any combination of such backend components, middleware components, or frontend components. The components of the system may be interconnected by any form or medium of digital data communication (e.g., communication network). Examples of the communication network include: local area networks (LAN), wide area networks (WAN), the Internet, and blockchain networks.

The computer system may include a client and a server. The client and the server are generally far from each other and usually interact through the communication network. The relationship between the client and the server is generated by computer programs that run on the corresponding computer and have a client-server relationship with each other. The server may be a cloud server, also known as a cloud computing server or a cloud host, which is a host product in the cloud computing service system to solve the shortcomings of difficult management and weak business scalability among the traditional physical host and VPS service (“Virtual Private Server”, or “VPS” for short).

Flowcharts and block diagrams in the drawings illustrate architectures, functions, and operations of possible implementations of systems, methods, and computer program products in accordance with various embodiments of the present disclosure. In this regard, each block in a flowchart or block diagram may represent a module, program segment, or portion of code that contains one or more executable instructions for implementing a specified logical function. It should also be noted that in some alternative implementations, the functions noted in the blocks may also occur in an order different from that noted in the drawings. For example, two successively represented blocks may actually be executed substantially in parallel, and they may sometimes be executed in the reverse order, depending on the functionality involved. It is also noted that each block of the block diagrams and/or flowcharts, and combinations of blocks in the block diagrams and/or flowcharts, may be implemented with a dedicated hardware-based system that performs the specified functions or operations, or may be implemented with a combination of dedicated hardware and computer instructions.

The units involved in the embodiments of the present disclosure may be implemented by means of software or hardware. The described units may also be provided in a processor, for example, may be described as: a processor, including an acquisition unit and a prediction unit. Here, the names of these units do not in some cases constitute limitations to such units themselves. For example, the acquisition unit may also be described as “a unit configured to acquire a target voice.”

In another aspect, the present disclosure further provides a computer readable medium. The computer readable medium may be included in the apparatus in the above described embodiments, or a stand-alone computer readable medium not assembled into the apparatus. The computer readable medium stores one or more programs. The one or more programs, when executed by the apparatus, cause the apparatus to: acquire a target voice; and input the target voice into a pre-trained deep neural network to obtain whether the target voice has a sub-voice in each of a plurality of preset direction intervals, the deep neural network being used to predict whether the voice has a sub-voice in each of the plurality of direction intervals.

In another aspect, an embodiment of the present disclosure further provides a computer readable medium. The computer readable medium may be included in the apparatus in the above described embodiments, or a stand-alone computer readable medium not assembled into the apparatus. The computer readable medium stores one or more programs. The one or more programs, when executed by the apparatus, cause the apparatus to: acquire a training sample, a voice sample in the training sample including a sub-voice in at least one preset direction interval; input the voice sample into the deep neural network to obtain a prediction result, the deep neural network being used to predict whether the voice has a sub-voice in each of a plurality of direction intervals; and train the deep neural network based on the prediction result, to obtain a trained deep neural network.

According to the solution of the present disclosure, each direction interval may be separately predicted, so as to accurately determine whether the target voice has a sub-voice in each direction interval, to realize accurate prediction.

The above description is only a preferred embodiment of the disclosure and a description of the technical principles employed. It should be understood by those skilled in the art that the scope of the disclosure referred to in this disclosure is not limited to the technical solutions formed by specific combinations of the above-mentioned technical features, but also covers other technical solutions formed by any combination of the above-mentioned technical features or equivalents thereof without departing from the inventive concept. For example, the above-mentioned features and the technical features having similar functions disclosed in the present disclosure are replaced with each other.

What is claimed is:

1. A method for detecting a voice, the method comprising:
acquiring a target voice; and
inputting the target voice into a pre-trained deep neural network to obtain whether the target voice has a sub-voice in each of a plurality of preset direction intervals, the deep neural network being used to predict whether the voice has a sub-voice in each of the plurality of direction intervals.

2. The method according to claim 1, wherein the deep neural network comprises a multi-head fully connected network, and an output of the multi-head fully connected network is used to represent whether the voice has the sub-voice in each of the plurality of direction intervals respectively, wherein direction intervals corresponding to any two fully connected networks in the multi-head fully connected network are different.

3. The method according to claim 2, wherein the deep neural network further comprises a feature-extraction network and a convolutional neural network;
the inputting the target voice into a pre-trained deep neural network to obtain whether the target voice has a sub-voice in each of a plurality of preset direction intervals, comprises:
inputting the target voice into the pre-trained deep neural network, and extracting a voice feature of the target voice based on the feature-extraction network; and
processing the voice feature using the convolutional neural network to obtain a voice feature after convolution to be input into the multi-head fully connected network.

4. The method according to claim 3, wherein the deep neural network further comprises a Fourier transform network;
the extracting a voice feature of the target voice based on the feature-extraction network, comprises:
performing Fourier transform on the target voice using the Fourier transform network to obtain a plural form vector;
normalizing a real part and an imaginary part of the vector using the feature-extraction network to obtain a normalized real part and a normalized imaginary part; and
using the normalized real part and the normalized imaginary part as the voice feature of the target voice.

5. The method according to claim 4, wherein the method further comprises:
determining a logarithm of a modulus length of the vector using the feature-extraction network; and
the using the normalized real part and the normalized imaginary part as the voice feature of the target voice, comprises:
using the normalized real part, the normalized imaginary part and the logarithm as the voice feature of the target voice.

6. The method according to claim 3, wherein the inputting the target voice into a pre-trained deep neural network to obtain whether the target voice has a sub-voice in each of a plurality of preset direction intervals, further comprises:
for each fully connected network in the multi-head fully connected network, inputting the voice feature after convolution into the fully connected network to obtain a probability that the target voice has a sub-voice in a direction interval corresponding to the fully connected network.

7. The method according to claim 6, wherein the deep neural network further comprises a concate layer;
the inputting the target voice into a pre-trained deep neural network to obtain whether the target voice has a sub-voice in each of a plurality of preset direction intervals, further comprises:
merging probabilities corresponding to the multi-head fully connected network to obtain a to-be-output probability set.

8. The method according to claim 2, wherein a fully connected network in the multi-head fully connected network comprises a fully connected layer, an affine layer and a softmax layer.

9. A method for training a deep neural network, the method comprising:
acquiring a training sample, wherein a voice sample in the training sample comprises a sub-voice in at least one preset direction interval;
inputting the voice sample into the deep neural network to obtain a prediction result, the deep neural network being used to predict whether the voice has a sub-voice in each of a plurality of direction intervals; and
training the deep neural network based on the prediction result, to obtain a trained deep neural network.

10. The method according to claim 9, wherein the deep neural network comprises a multi-head fully connected network, and an output of the multi-head fully connected network is used to represent whether a voice has a sub-voice in each of the plurality of direction intervals respectively, wherein direction intervals corresponding to any two fully connected networks in the multi-head fully connected network are different.

11. The method according to claim 10, wherein the inputting the voice sample into the deep neural network to obtain a prediction result, comprises:
inputting the voice sample into the deep neural network, determining a feature of the voice sample using the deep neural network to obtain a to-be-processed voice feature, wherein the training sample further comprises direction information of each sub-voice in the voice sample, and the to-be-processed voice feature comprises a to-be-processed sub-voice feature corresponding to each sub-voice in the voice sample;
for each to-be-processed sub-voice feature of the sub-voice, determining in the multi-head fully connected network a fully connected network corresponding to a direction interval in which a direction indicated by the direction information of the sub-voice is located, and using the fully connected network as a fully connected network into which the to-be-processed sub-voice feature is to-be-input; and
determining whether the voice sample has the sub-voice in each of the plurality of direction intervals using the multi-head fully connected network.

12. The method according to claim 11, wherein a training network structure of the deep neural network further comprises a feature-oriented network;
the for each to-be-processed sub-voice feature of the sub-voice, determining in the multi-head fully connected network a fully connected network corresponding to a direction interval in which a direction indicated by the direction information of the sub-voice is located, and using the fully connected network as a fully connected network into which the to-be-processed sub-voice feature is to-be-input, comprises:
for each to-be-processed sub-voice feature of the sub-voice, determining, using the feature-oriented network, in the multi-head fully connected network the fully connected network corresponding to the direction interval in which the direction indicated by the direction information of the sub-voice is located, and using the fully connected network as the fully connected network into which the to-be-processed sub-voice feature is to-be-input.

13. The method according to claim 11, wherein the determining whether the voice sample has a sub-voice in each of the plurality of direction intervals using the multi-head fully connected network, comprises:
for each to-be-processed sub-voice feature, using the to-be-processed sub-voice feature for forward propagation on the corresponding fully connected network to obtain a probability that the voice sample has the sub-voice in each of the plurality of direction intervals.

14. The method according to claim 11, wherein the deep neural network further comprises a feature-extraction network and a convolutional neural network:
the determining a feature of the voice sample using the deep neural network to obtain a to-be-processed voice feature, comprises:
extracting a voice feature of the voice sample based on the feature-extraction network; and
processing the extracted voice feature using the convolutional neural network to obtain the to-be-processed voice feature to be input into the multi-head fully connected network.

15. The method according to claim 14, wherein the deep neural network further comprises a Fourier transform network;
the extracting a voice feature of the voice sample based on the feature-extraction network, comprises:
performing Fourier transform on the voice sample using the Fourier transform network to obtain a plural form vector;
normalizing a real part and an imaginary part of the vector using the feature-extraction network to obtain a normalized real part and a normalized imaginary part; and
using the normalized real part and the normalized imaginary part as the voice feature of the voice sample.

16. The method according to claim 13, wherein the training the deep neural network based on the prediction result, to obtain a trained deep neural network, comprises:
performing back propagation in the training network structure based on the obtained probability, to update a parameter of the convolutional neural network and a parameter of the multi-head fully connected network.

17. The method according to claim 16, wherein the performing back propagation in the training network structure based on the obtained probability, to update a parameter of the convolutional neural network and a parameter of the multi-head fully connected network, comprises:
for each obtained probability, determining a loss value corresponding to the probability, and performing back propagation in the fully connected network that obtains the probability using the loss value, to obtain a first result corresponding to the probability;
merging the obtained first results using the feature-oriented network to obtain a first result set; and
performing back propagation in the convolutional neural network using the first result set to update the parameter of the convolutional neural network and the parameter of the multi-head fully connected network.

18. An electronic device, comprising:
one or more processors; and
a storage apparatus storing one or more programs,
wherein the one or more programs, when executed by the one or more processors, cause the one or more processors to perform operations, comprising:
acquiring a target voice; and
inputting the target voice into a pre-trained deep neural network to obtain whether the target voice has a sub-voice in each of a plurality of preset direction intervals, the deep neural network being used to predict whether the voice has a sub-voice in each of the plurality of direction intervals.

19. The electronic device according to claim 18, wherein the deep neural network comprises a multi-head fully connected network, and an output of the multi-head fully connected network is used to represent whether the voice has the sub-voice in each of the plurality of direction intervals respectively, wherein direction intervals corresponding to any two fully connected networks in the multi-head fully connected network are different.

20. The electronic device according to claim 19, wherein the deep neural network further comprises a feature-extraction network and a convolutional neural network;
the inputting the target voice into a pre-trained deep neural network to obtain whether the target voice has a sub-voice in each of a plurality of preset direction intervals, comprises:
inputting the target voice into the pre-trained deep neural network, and extracting a voice feature of the target voice based on the feature-extraction network; and
processing the voice feature using the convolutional neural network to obtain a voice feature after convolution to be input into the multi-head fully connected network.

21. The electronic device according to claim 20, wherein the deep neural network further comprises a Fourier transform network;
the extracting a voice feature of the target voice based on the feature-extraction network, comprises:
performing Fourier transform on the target voice using the Fourier transform network to obtain a plural form vector;
normalizing a real part and an imaginary part of the vector using the feature-extraction network to obtain a normalized real part and a normalized imaginary part; and
using the normalized real part and the normalized imaginary part as the voice feature of the target voice.

22. The electronic device according to claim 21, wherein the operations further comprise:
determining a logarithm of a modulus length of the vector using the feature-extraction network; and
the using the normalized real part and the normalized imaginary part as the voice feature of the target voice, comprises:
using the normalized real part, the normalized imaginary part and the logarithm as the voice feature of the target voice.

23. The electronic device according to claim 19, wherein the inputting the target voice into a pre-trained deep neural network to obtain whether the target voice has a sub-voice in each of a plurality of preset direction intervals, further comprises:
for each fully connected network in the multi-head fully connected network, inputting the voice feature after convolution into the fully connected network to obtain a probability that the target voice has a sub-voice in a direction interval corresponding to the fully connected network.

24. The electronic device according to claim 23, wherein the deep neural network further comprises a concate layer;
the inputting the target voice into a pre-trained deep neural network to obtain whether the target voice has a sub-voice in each of a plurality of preset direction intervals, further comprises:
merging probabilities corresponding to the multi-head fully connected network to obtain a to-be-output probability set.

25. The electronic device according to claim 19, wherein a fully connected network in the multi-head fully connected network comprises a fully connected layer, an affine layer and a softmax layer.

26. An electronic device, comprising:
one or more processors; and
a storage apparatus storing one or more programs,
wherein the one or more programs, when executed by the one or more processors, cause the one or more processors to perform operations, comprising:
acquiring a training sample, wherein a voice sample in the training sample comprises a sub-voice in at least one preset direction interval;
inputting the voice sample into the deep neural network to obtain a prediction result, the deep neural network being used to predict whether the voice has a sub-voice in each of a plurality of direction intervals; and
training the deep neural network based on the prediction result, to obtain a trained deep neural network.

27. The electronic device according to claim 26, wherein the deep neural network comprises a multi-head fully connected network, and an output of the multi-head fully connected network is used to represent whether a voice has a sub-voice in each of the plurality of direction intervals respectively, wherein direction intervals corresponding to any two fully connected networks in the multi-head fully connected network are different.

28. The electronic device according to claim 27, wherein the inputting the voice sample into the deep neural network to obtain a prediction result, comprises:
inputting the voice sample into the deep neural network, determining a feature of the voice sample using the deep neural network to obtain a to-be-processed voice feature, wherein the training sample further comprises direction information of each sub-voice in the voice sample, and the to-be-processed voice feature comprises a to-be-processed sub-voice feature corresponding to each sub-voice in the voice sample;
for each to-be-processed sub-voice feature of the sub-voice, determining in the multi-head fully connected network a fully connected network corresponding to a direction interval in which a direction indicated by the direction information of the sub-voice is located, and using the fully connected network as a fully connected network into which the to-be-processed sub-voice feature is to-be-input; and
determining whether the voice sample has the sub-voice in each of the plurality of direction intervals using the multi-head fully connected network.

29. The electronic device according to claim 28, wherein a training network structure of the deep neural network further comprises a feature-oriented network;
the for each to-be-processed sub-voice feature of the sub-voice, determining in the multi-head fully connected network a fully connected network corresponding to a direction interval in which a direction indicated by the direction information of the sub-voice is located, and using the fully connected network as a fully connected network into which the to-be-processed sub-voice feature is to-be-input, comprises:
for each to-be-processed sub-voice feature of the sub-voice, determining, using the feature-oriented network, in the multi-head fully connected network the fully connected network corresponding to the direction interval in which the direction indicated by the direction information of the sub-voice is located, and using the fully connected network as the fully connected network into which the to-be-processed sub-voice feature is to-be-input.

30. The electronic device according to claim 28, wherein the determining whether the voice sample has a sub-voice in each of the plurality of direction intervals using the multi-head fully connected network, comprises:
for each to-be-processed sub-voice feature, using the to-be-processed sub-voice feature for forward propagation on the corresponding fully connected network to obtain a probability that the voice sample has the sub-voice in each of the plurality of direction intervals.

31. The electronic device according to claim 27, wherein the deep neural network further comprises a feature-extraction network and a convolutional neural network:
the determining a feature of the voice sample using the deep neural network to obtain a to-be-processed voice feature, comprises:
extracting a voice feature of the voice sample based on the feature-extraction network; and
processing the extracted voice feature using the convolutional neural network to obtain the to-be-processed voice feature to be input into the multi-head fully connected network.

32. The electronic device according to claim 31, wherein the deep neural network further comprises a Fourier transform network;
the extracting a voice feature of the voice sample based on the feature-extraction network, comprises:
performing Fourier transform on the voice sample using the Fourier transform network to obtain a plural form vector;
normalizing a real part and an imaginary part of the vector using the feature-extraction network to obtain a normalized real part and a normalized imaginary part; and
using the normalized real part and the normalized imaginary part as the voice feature of the voice sample.

33. The electronic device according to claim 30, wherein the training the deep neural network based on the prediction result, to obtain a trained deep neural network, comprises:
performing back propagation in the training network structure based on the obtained probability, to update a parameter of the convolutional neural network and a parameter of the multi-head fully connected network.

34. The electronic device according to claim 33, wherein the performing back propagation in the training network structure based on the obtained probability, to update a parameter of the convolutional neural network and a parameter of the multi-head fully connected network, comprises:
for each obtained probability, determining a loss value corresponding to the probability, and performing back propagation in the fully connected network that obtains the probability using the loss value, to obtain a first result corresponding to the probability;
merging the obtained first results using the feature-oriented network to obtain a first result set; and
performing back propagation in the convolutional neural network using the first result set to update the parameter of the convolutional neural network and the parameter of the multi-head fully connected network.

35. A non-transitory computer readable storage medium, storing a computer program thereon, wherein the program, when executed by a processor, implements the method according to claim 1.
